(19) United States
(12) Patent Application Publication
(10) Pub. No.: US 2013/0332357 A1
(43) Pub. Date: Dec. 12, 2013

(54) SETTING PEER-TO-PEER AUTHORIZATION LEVELS WITH SOCIAL NETWORK CONTENT

(71) Applicants: Travis Harrison Kroll Green, Washington, DC (US); Narelle Cozens, New York, NY (US); Avery Pennarun, New York, NY (US); Peter Schmitt, Jersey City, NJ (US); Michael DePasquale, Rutherford, NJ (US); Boris Mizhen, Brooklyn, NY (US)

(72) Inventors: Travis Harrison Kroll Green, Washington, DC (US); Narelle Cozens, New York, NY (US); Avery Pennarun, New York, NY (US); Peter Schmitt, Jersey City, NJ (US); Michael DePasquale, Rutherford, NJ (US); Boris Mizhen, Brooklyn, NY (US)

(73) Assignee: Google Inc., Mountain View, CA (US)

(21) Appl. No.: 13/490,423

(22) Filed: Jun. 6, 2012

(51) Int. Cl. G06Q 40/00

(52) U.S. Cl. 705/44

(57) ABSTRACT

The invention provides a computer-implemented method for using the social networking content of a user to determine authentication levels required for a peer-to-peer transaction. A user inputs transaction counter-party and transaction details into a payment application. The information can be transmitted to a server located in a peer-to-peer payment system. The system may search the social network content of the user to determine the account information of the counter-party and to assess the security risk of the counter-party according to a preconfigured set of factors that define the strength of the connection to the user. These factors may include the counter-party's status in the user's social networks, frequency of contact, prior transactions, or other factors that further establish a relationship. The system may determine the level of transaction authentication required to process the transaction. The user may enter the authentication data to complete the transaction.

### TECHNICAL FIELD

The present disclosure relates generally to peer-to-peer transactions, and more particularly to using the social networking content of a user to determine transaction authentication levels.

### BACKGROUND

Users of smartphones and other similar devices are conducting an increasing number of electronic transactions. While financial transactions with merchants have become much more user-friendly and commonplace, users are additionally employing their devices to conduct transactions with other mobile device users. These peer-to-peer transactions often require an cumbersome amount of data input to identify the other party and the other party's financial account information in the transaction and to conduct a transaction.

Users of this technology are desirous of a simpler and faster method of locating the account of a transaction counter-party and authenticating the transaction. An example of a circumstance in which users may conduct this type of peer-to-peer transaction might be when two people regularly dine together at a restaurant. If one person pays the restaurant for the bill and the other member of the party would like to pay the person his share of the bill, entering account information of the payee and multiple levels of authentication every time the two people share a meal would be burdensome. This requirement may reduce the likelihood that the user would employ this service.

If the user were able to bypass some or all of the authentication steps without sacrificing security, the speed and simplicity of the transaction would be greatly enhanced. If the user could further conduct the transaction without inputting all of the recipients account information, the process could be even more convenient for the user.

### SUMMARY

An aspect of the present invention provides a computer-implemented method for using the social networking content of a user to determine authentication levels required for a peer-to-peer transaction. A user installs a peer-to-peer payment application (“PPA”) on their mobile device. The user inputs information to identify the transaction counter-party and the transaction details, such as an amount of money to transmit to the counter-party. The information can be transmitted to a server located in a peer-to-peer payment system (“PPS”). The PPS may search the social network content of the user to determine the account information of the counter-party. The PPS also searches the social network content of the user to assess the security risk of the counter-party according to a preconfigured set of factors that define the strength of the connection to the user. These factors may include the counter-party's status in the user's social networks, frequency of contact, prior transactions, or other factors that further establish a relationship. The PPS may determine the level of transaction authentication required to process the transaction. The PPS may transmit the authentication requirements to the PPA on the user device. The user may enter the authentication data to complete the transaction.

Another aspect of the present invention provides a computer program product that is installed on a user's device and on a server located in a PPS for using the social networking content of a user to determine authentication levels required for a peer-to-peer transaction. The computer program product includes a non-transitory computer-readable storage device having computer-readable program instructions stored therein. The computer-readable program instructions include computer program instructions for transmitting the user's transaction request to the PPS server; locating the transaction counter-party from the user's social network content; determining the authentication requirement for the transaction based on the strength of the counter-party's connection to the user; transmitting the authentication requirement list to a PPA; and conducting the transaction.

Another aspect of the present invention provides an apparatus for using the social networking content of a user to determine authentication levels required for a peer-to-peer transaction. The apparatus includes a web browser application with a PPA logically coupled to the web browser application. The PPA is configured for interfacing with the user and transmitting the user's transaction request to the PPS server. The apparatus includes a PPS server configured for locating the transaction counter-party from the user's social network content; determining the authentication requirement for the transaction based on the strength of the counter-party's connection to the user; and transmitting the authentication requirement list to a PPA.

These and other aspects, objects, features, and advantages of the exemplary embodiments will become apparent to those having ordinary skill in the art upon consideration of the following detailed description of illustrated exemplary embodiments, which include the best mode of carrying out the invention as presently presented.

### BRIEF DESCRIPTION OF THE DRAWINGS

FIG. 1 is a block diagram depicting an operating environment of a Peer-to-Peer Payment Application (“PPA”), in accordance with certain exemplary embodiments.

FIG. 2 is a block flow diagram depicting a method for using the social networking content of a user to determine authentication levels required for a peer-to-peer transaction, in accordance with certain exemplary embodiments.

### DETAILED DESCRIPTION OF THE EXEMPLARY EMBODIMENTS

### Overview

The exemplary embodiments provide a peer-to-peer payment application (“PPA”) that can utilize a user's social graph for identifying counter-party accounts for a peer-to-peer transaction with a mobile device and setting the authorization level for the transaction. The social graph of a user refers to all of a user's contacts, friends, family, and other members of a user's online network. The social graph not only determines the members of a user's network, but also determines how the members are related and how closely the members are related.

A user installs a PPA on his mobile device. The PPA can provide a user interface for entering configuration information and establishing an account. The user can utilize the PPA to conduct peer-to-peer financial transactions. Peer-to-peer transactions can be conducted between the user and a recipient. The recipient can be another consumer or a small business.

The user enters information into the PPA including information to identify the counter-party and transaction details, such as an amount to pay to the counter-party. In certain exemplary embodiments, the user may enter the counter-party's name or other identifying information such as an email address or a phone number. The PPA transmits the information and the transaction details to the server on a peer-to-peer payment system (“PPS”). In an alternate embodiment, the user may simply send the identity information and the transaction information directly to the PPS via email, text, instant message, or any other type of communication available to the user.

In an alternate embodiment, the user may input instructions to manually alter the authorization levels required for a transaction counter-party. The authorization levels may be configurable by a user for some or all types of transactions. Alternatively, the payment system may restrict the authorization levels for some or all transactions from being altered by the user.

The PPS compares the identity information with a compilation of social network data from the user. From the social network data, the PPS searches for the user's contacts, friends, business associates, family members, or other contacts to clearly identify the intended recipient of the transaction. The PPS may extract the identity from any social network data available from the user's activities. Examples of locations available from which the PPS may gather data may include, but not be limited to, social network websites accounts, such as on FACEBOOK or GOOGLE+, contact list entries, email contacts, phone contacts, or other programs and applications running on user devices or accessed via the internet or other network.

The PPS evaluates the counter-party to determine the authentication level required to conduct a transaction. One of the criteria used by the PPS to evaluate the counter-party may be based on the status of the counter-party on the social network status, such as a “friend” on FACEBOOK or a friend of a friend. Other criteria may include, but would not be limited to, frequency of emails or texts with a contact, number of social network applications on which the counter-party appears, or the number of previous transactions with the user.

After determining the strength of the connection of the counter-party to the user, the PPS establishes the authentication level required for the user to complete the transaction. The PPS transmits the level to the PPA on the user device, which prompts the user for the required authentication. The user may enter the required authorization and proceed with the transaction.

Examples of authorization procedures that may be required by the PPS might include, but would not be limited to, signing in to the PPA, providing a PIN number, password re-entry, answering a challenge question, answering a challenge-response test such as a CAPTCHA, confirming additional details about the counter-party identification or corresponding account information, or other authorization steps that may help limit fraudulent transactions.

The PPA can be embodied as a stand-alone application program or as a companion program to a web browser, for example, as a companion program to a Hypertext Markup Language revision 5 (“HTML5”) compliant web browser or other type of web browser having messaging and storage capabilities. While certain embodiments are described in which parts of the PPA are implemented in software, it will be appreciated that one or more acts or functions of the PPA may be performed by hardware, software, or a combination thereof, as may be embodied in one or more computing systems.

The functionality of the exemplary embodiments will be explained in more detail in the following description, read in conjunction with the figures illustrating the program flow.

### System Architecture

Turning now to the drawings, in which like numerals indicate like (but not necessarily identical) elements throughout the figures, exemplary embodiments of the invention are described in detail.

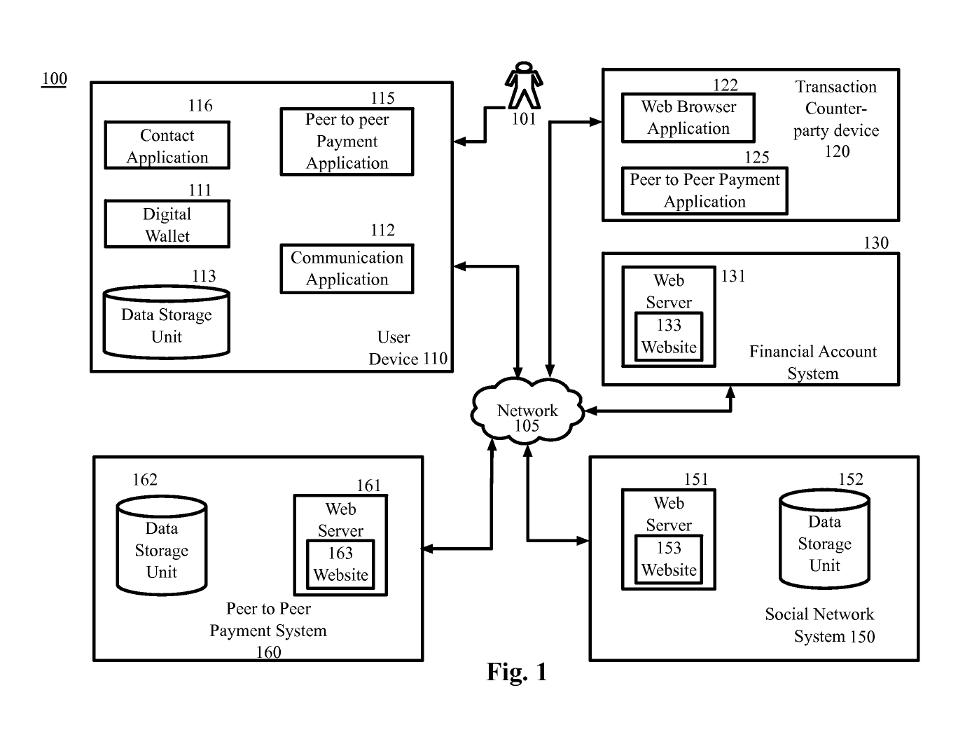

FIG. 1 is a block diagram depicting an operating environment 100 for a peer-to-peer payment application (“PPA”), in accordance with certain exemplary embodiments. As depicted in FIG. 1, the system 100 includes network devices 110, 120, 150 and 160 that are configured to communicate with one another via one or more networks 105.

Each network 105 includes a wired or wireless telecommunication means by which network devices (including devices 110, 120, 150, 160) can exchange data. For example, each network 105 can include a local area network (“LAN”), a wide area network (“WAN”), an intranet, an Internet, a mobile telephone network, or any combination thereof. Throughout the discussion of exemplary embodiments, it should be understood that the terms “data” and “information” are used interchangeably herein to refer to text, images, audio, video, or any other form of information that can exist in a computer-based environment.

Each network device 110, 120, 130, 150 and 160 includes a device having a communication module capable of transmitting and receiving data over the network 105. For example, each network device 110, 120, 130, 150 and 160 can include a server, desktop computer, laptop computer, tablet computer, smart phone, handheld computer, personal digital assistant (“PDA”), or any other wired or wireless, processor-driven device. In the exemplary embodiment depicted in FIG. 1, the network devices 110, 120, 130, 150 and 160 are operated by end-users or consumers, likely transaction counter-party users, financial account operators, social network system operators, and a peer-to-peer payment system operator, respectively.

The user 101 can use the communication application 112, such as a web browser application or a stand-alone application, to view, download, upload, or otherwise access documents or web pages via a distributed network 105. The network 105 includes a wired or wireless telecommunication system or device by which network devices (including devices 110, 120, 130, 150, and 160) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages. Throughout the discussion of exemplary embodiments, it should be understood that the terms “data” and “information” are used interchangeably herein to refer to text, images, audio, video, or any other form of information that can exist in a computer based environment.

The communication application 112 can interact with web servers (or other computing devices) connected to the network 105, transaction counter-parties 125, web server 151 of the Social Network System 150, and the web server 161 of the PPS 160.

The user device 110 may include a digital wallet application module 111. The digital wallet 111 may encompass any application, hardware, software, or process the user device 110 may employ to assist the device to complete a purchase transaction. The digital wallet 111 can interact with the web browser application 112 or can be embodied as a companion application of the web browser application 112. As a companion application, the digital wallet 111 executes within the web browser application 112. That is, the digital wallet 111 may be an application program embedded in the web browser application 112.

The user device 110 may include a PPA 115. The PPA 115 can interact with the web browser application 112 or be embodied as a companion application of the web browser application 112 and execute within the web browser application 112. The PPA 115 may further be embodied as a companion application of the digital wallet 111 and execute within the digital wallet 111. The PPA 115 may employ a software interface that may open in the digital wallet application 111 or may open in the web browser application 112. The interface can allow the user 101 to configure the PPA 115 and the user account on the PPS 160.

The PPA 115 can be used to send transaction requests to the PPS 160 and receive an authorization request from the PPS 160. The PPS 160 that develops authorization requirement and prosecutes the transaction can include a set of computer-readable program instructions, for example, using JavaScript, that enable the PPS 160 to interact with the PPA 115.

The user device 110 includes a data storage unit 113 accessible by the PPA 115 and the web browser application 112. The exemplary data storage unit 113 can include one or more tangible computer-readable media. The data storage unit 113 can be stored on the user device 110 or can be logically coupled to the user device 110. For example, the data storage unit 113 can include on-board flash memory and/or one or more removable memory cards or removable flash memory.

The user device 110 may include one or more contact applications 116. A contact application 116 may be any program or application on the user device 110 or accessible by the user device 110 that maintains a list of contacts of the user that the PPS 160 may access. Examples of contact applications 116 might include, but not be limited to, email applications, text applications, instant messaging, calendar invite lists, or contact databases such as OUTLOOK or ACT. The contacts from a contact application 116 may be prioritized by factors such as frequency of communication with user 101, the number of contact applications on which a particular contact appears, or any other prioritizing factors which may be extracted from the applications.

The PPS 160 utilizes a PPS server 161. The PPS server 161 may represent the computer implemented system that the PPS 160 employs to configure user accounts, create and maintain user profiles, communicate with the social network system 150, locating the transaction counter-party from the user's social network content, determining the authentication requirement for the transaction based on the strength of the counter-party's connection to the user, and transmitting the authentication requirement level to a PPA 115, and conduct the transaction. The PPS website 163 may represent any web-based interface that allows users to interact with the PPS 160 to configure the user accounts and change account settings. The PPS server 161 can communicate with one or more social network systems 150, one or more transaction counter-party devices 120, a financial account system 130, and a user device 110 via any available technologies. These technologies may include, but would not be limited to, an Internet connection via the network 105, email, text, instant messaging, or other suitable communication technologies. The PPS 160 may include a data storage unit 162 accessible by the server 161 of the PPS 160. The data storage unit 162 can include one or more tangible computer-readable storage devices.

In alternate embodiments, some or all of the functions or action of the PPS 160 may be performed by the user device 110 or executed on the user device 110.

The social network system 150 utilizes a social network system server 151. The social network server 151 may represent the computer-implemented system that the social network system 150 employs to host the social network website 153 and all of the profiles and communities that use the social network website 153. The social network website 153 may represent any web-based community that allows users to interact over the Internet with others who typically share a common interest. Examples of the social network websites 153 that the user 101 may belong to or interact with may include, but would not be limited to, FACEBOOK, GOOGLE+, or LINKEDIN.

The social network system 150 may provide the PPS 160 with a list of members of the user's online community. The social network system 150 may identify the potential transaction counter-party and establish the strength the connection with the user 101. This may be determined by factors that may apply to the structure of each particular social network system 150. For example, a social network system such as FACEBOOK may categorize members of the community as “friends” or “friends of friends” and LINKEDIN may categorize members as first, second, or third degree contacts.

The social network system server 151 can communicate with a PPS 160 and user devices 110 via any available technologies. These technologies may include, but would not be limited to, an Internet connection via the network 105, email, text, instant messaging, or other suitable communication technologies. The social network system 150 may include a data storage unit 152 accessible by the server 151 of the social network system 150. The data storage unit 152 can include one or more tangible computer-readable storage devices.

The transaction counter-party device 120 may represent the devices with which the user 101 may conduct a peer-to-peer transaction. Like the user device 110, the transaction counter-party device 120 may be a mobile device, (for example, notebook computer, tablet computer, netbook computer, personal digital assistant (PDA), video game device, GPS locator device, cellular telephone, smartphone, or other mobile device), personal computer, or other appropriate technology that includes or is coupled to a web browser application module 112, such as GOOGLE'S CHROME, MICROSOFT'S INTERNET EXPLORER, or MOZILLA'S FIREFOX.

The transaction counter-party device 120 may include a Peer-to-Peer Payment Application (“PPA”) 125, a counterpart to PPA 115, or a compatible transaction application that will allow transactions with the user device 110.

The financial account system 130 may employ a web server 131 and a website 133. The financial account system represents any institution or entity that may host the financial account of the user 101 or the transaction counter-party. The account may be utilized to send or receive payments conducted on the PPS 160. Examples of financial accounts that the financial account system 130 may represent include, but would not be limited to, credit card accounts, debit card accounts, bank accounts, or other financial accounts.

It will be appreciated that the network connections shown are exemplary and other means of establishing a communications link between the computers and devices can be used. Moreover, those having ordinary skill in the art having the benefit of the present disclosure will appreciate that the user device 110, transaction counter-party device 120, financial account system 130, social network system 150, and PPS 160 illustrated in FIG. 1 can have any of several other suitable computer system configurations. For example, a user device 110 embodied as a mobile phone or handheld computer may not include all the components described above.

### System Process

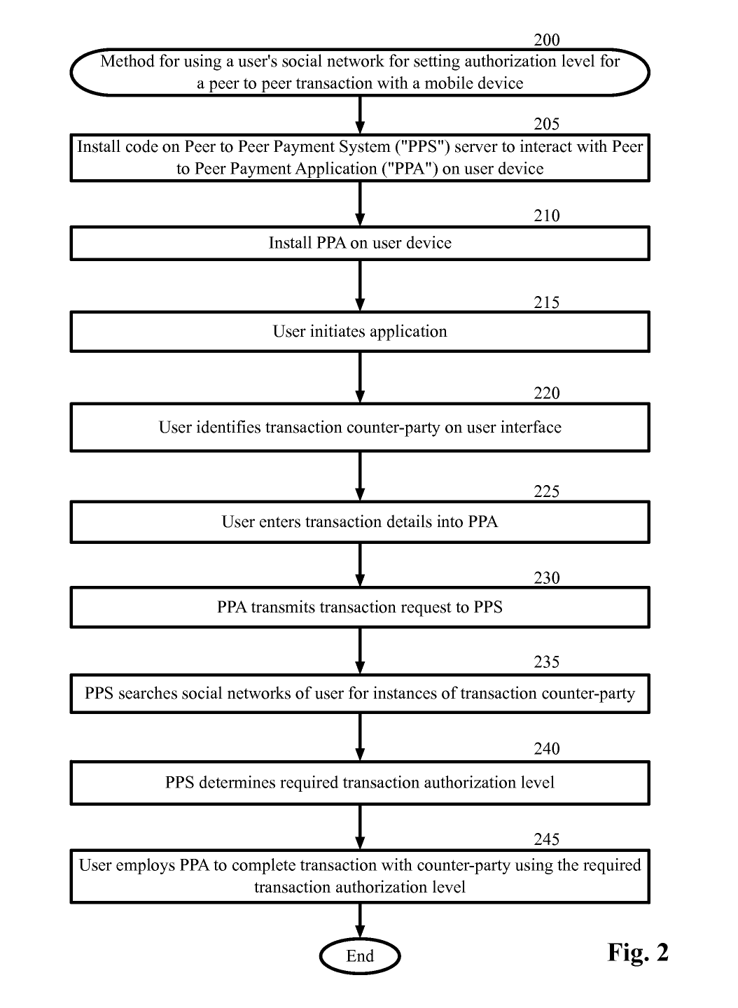

The components of the exemplary operating environment 100 are described hereinafter with reference to the exemplary methods illustrated in FIG. 2. The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described may be performed by hardware, software, or a combination thereof, as may be embodied in one or more computing systems.

FIG. 2 is a flow chart depicting a method 200 for using the location data and the social network of a user for identifying likely counter-parties for a peer-to-peer transaction with a mobile device, in accordance with certain exemplary embodiments.

With reference to FIGS. 1 and 2, in block 205, the peer-to-peer payment system (“PPS”) 160 installs computer-readable program instructions on the PPS server 161 for interacting with the peer-to-peer payment application (“PPA”) 115 on the user device 110. Additionally, the PPS 160 installs computer-readable program instructions on the PPS server 161 for interacting with the social network system 150. In an exemplary embodiment, these computer-readable program instructions may be implemented as an embedded script, such as JavaScript, in the PPS server 161.

In block 210, the user 101 installs a PPA 115 on the user device 110. In certain exemplary embodiments, the user 101 may navigate to a website of a provider of the PPA 115 and download and install the PPA 115. The website that provides the PPA 115 may be the PPS website 153. The PPA 115 may be embedded in a digital wallet 112 on a user device 110. The user 101 may utilize a user interface of the PPA 115 to configure the PPA 115. The user 101 may configure privacy settings provided by the PPA 115. Additionally, the user 101 may communicate with the computer-readable program instructions on the PPS 160 to establish user identification and transaction configuration. The communication with the PPS 160 may be made via any available technology including, but not limited to, an Internet connection via the network 105, text, email, or a cellular connection.

In block 215, the user 101 initiates the PPA 115 by actuating a physical or virtual button, making a motion such as a “tap” or swipe with the user device 110, speaking a voice command, or performing any other initiation process.

In block 220, the user 101 identifies the transaction counter-party and enters the identity into the PPA 115. In an exemplary embodiment of the invention, the PPA 115 allows the user 101 to select a transaction counter-party from one or more of the contact applications on the user device 110. In an alternate embodiment, the PPA 115 may allow the user 101 to enter only the counter-party's email address, name, phone number, or any other identification data. In this embodiment, the user 101 may enter the identification into a user interface of the PPA 115 or transmit the identification to the peer-to-peer payment system (“PPS”) 160 directly. The transmission to the PPS 160 may be via email, text, instant message, or any other appropriate communication technology. In another alternate embodiment of the invention, the user device 110 may recognize the transaction counter-party device 120 via near field communication or another communication technology that allows the devices 110, 120 to communicate, such as WiFi, BLUETOOTH, infrared, or other appropriate technology. If the devices 110, 120 are able to communicate, the counter-party device 120 may transmit the counter-party identity to the user device 110 for use by the PPA 115.

In block 225, the user 101 submits the transaction data to the PPS 160. The transaction details may be entered into a user interface of the PPS 115 or transmitted directly to the PPS 160 from the user device 110 in a similar manner to the transmitting of the counter-party identity as described in block 220. In the exemplary embodiment of the invention, the transaction is a peer-to-peer financial transaction.

In alternate embodiments of the invention, the transaction may be merely an exchange of information or other type of non-financial transaction. One skilled in the art might recognize that examples of such a transaction that might include, but would not be limited to, exchanging contact information, transferring event information such as a concert, transferring data files, transmitting directions, or any other transaction that might benefit from the present invention. One skilled in the art might also envision the invention being used in a financial transaction that is not limited to peer-to-peer. This might include, but would not be limited to, financial transactions with merchants or financial institutions.

In block 230, if the user 101 has entered the identification of the counter-party and the transaction data into the PPA 115, the PPA 115 transmits the data to the PPS 160. The PPS 160 receives the identification and transaction data and stores it in the user profile created on the PPS server 161.

In block 235, the PPS 160 compares the identity data of the transaction counter-party with a compilation of the social graph of the user 101. The social graph of a user refers to all of a user's contacts, friends, family, and other members of a user's online network. The social graph not only determines the members of a user's network, but also determines how the members are related and how closely the members are related. The social graph can be compiled from the social networks of which the user is a member, email contacts, text contacts, frequent transaction parties, and other suitable sources.

From the social network data, the PPS 160 searches the identities of the user's contacts, friends, business associates, family members, or any other identity that can be extracted from the social network content. Examples of the social network websites 153 to which the user 101 may belong may include, but would not be limited to, FACEBOOK, GOOGLE+, or LINKEDIN.

The social network system 150 may provide the PPS 160 with a list of contacts from the user's online community from which to extract the counter-party's identity. The social network system 150 may further provide to the PPS 160 data concerning the relative strength of the connection between the counter-party and the user from the community and the user. The strength of the connection may be determined by factors that may apply to the structure of each particular social network system 150. For example, a social network system such as FACEBOOK may categorize members of the community as “friends” or “friends of friends” and LINKEDIN may categorize members as first, second, or third degree contacts.

The PPS 160 may additionally or alternatively extract identities from the contact applications 116 on a user device 110. A contact application 116 may be any program or application on the user device 110 or accessible by the user device 110 that maintains a list of contacts of the user 101 from which the PPS 160 may extract data. Examples of contact applications 116 might include, but not be limited to, email applications, text applications, instant messaging, calendar invite lists, or contact databases such as OUTLOOK or ACT. The strength of a transaction counter-party's connection to a user 101 may be prioritized by details gained from a contact application 116, such as frequency of communication with user 101, the number of different contact applications 116 on which a particular contact appears, or any other prioritizing factors which may be extracted from the data.

Other priority factors may be used to determine the strength of the connection of a contact to the user, such as if the potential transaction counter-party has made recent transactions by the device 120 using the same or a compatible peer-to-peer application. For instance, if the transaction counter-parties has an account on the PPS 160 and has made transactions with the user 101 or contacts of the user 101, that action would strengthen the connection of the user 101 and the transaction counter-parties.

If the user 101 and the counter-party have repeated transactions having similar characteristics, the PPS 160 can recognize the patterns and increase the strength of connection. For example, if the user 101 and the counter-party have lunch every Friday, the PPS 160 may recognize the pattern and reduce the needed authorization level for the transactions. Another characteristic that the PPS 160 may recognize is the location of the transaction. For example, if a user 101 and the counter-party conduct a transaction at the same coffee shop twice a week, then the PPS 160 may recognize the pattern and reduce the needed authorization level for the transactions.

The final strength of the connection of the transaction counter-party to the user 101 may be determined by a configured ranking system. For example, the ranking system may assign scores to a transaction counter-party based upon each instance that they appear in the social network of the user 101. In certain exemplary embodiments, the PPS 160 applies the extracted data to a machine-learning algorithm or another statistical model to determine the most effective ranking system. For example, a machine-learning algorithm can be performed on the transaction counter-parties of one or more users to learn the ranking system that produces results having a fraud risk below an acceptable threshold. The machine-learning algorithm can be updated periodically.

In block 240, the PPS 160 assigns the transaction an authorization level. The level is determined by the strength of the connection of the counter-party to the user 101. For instance, a stronger connection may require a lower authorization procedure by the user 101, and a weaker connection may require a more extensive authorization procedure.

Examples of authorization procedures that may be required by the PPS 160 might include, but would not be limited to, signing in to the PPA 115, providing a PIN number, password re-entry, answering a challenge question, answering a challenge-response test such as a CAPTCHA, confirming additional details about the counter-party identification or corresponding account information, or other authorization steps that may help limit fraudulent transactions.

After determining the authorization procedures required for the transaction, the PPS 160 transmits the information to the PPA 115. The PPA 115 displays the requirements to the user 101 for authorization via the user interface of the PPA 115.

The PPS 160 can review the social graph of the user 101 to determine the authorization level without disclosing any of the personal identifiable information of the transaction counter-party.

In block 240, the user 101 enters the authorization data into the user interface of the PPA 115. Upon receipt of the authorization, the PPS 160 may proceed with the transaction. If the counter-party has an account on the PPS 160, the funds may be automatically transferred to the counter-party's financial account. If the user 101 has specified a financial account for the counter-party, the PPS 160 may transfer funds to that account. In a certain embodiment of the invention, a counter-party without an account on the PPS 160 may be required to register on the PPS 160 to receive the funds.

In an alternate embodiment, the PPA 115 can employ the location technology of the user device 110 to transmit the location of the device 110, and thus the location of the user 101 to the PPS 160. By establishing the location of the user 101, the PPS 160 may search for other devices within a certain proximity to the user 101 that may be active. The PPS 160 may search the social graph of the user to determine if any of the proximate device users are likely counter-parties. If one or more likely counter-party is identified, the PPS 115 may display the authorization level for each identified counter-party. The user 101 may select a contact from the list to be the counter-party for the current transaction with the knowledge of authorization level that will be required. Alternatively, the user 101 can decide to abandon the transaction.

In block 245, the user employs the PPA 115 to complete the transaction with the counter-party using the required transaction authorization level.

After completion of the transaction, the method 200 ends.

In alternate embodiments, some or all of the functions or action of the PPS 160 may be performed by the user device 110 or executed on the user device 110.

### General

Users may be allowed to limit or otherwise affect the operation of the features disclosed herein. For example, users may be given opportunities to opt-in or opt-out of the collection or use of certain data or the activation of certain features. In addition, users may be given the opportunity to change the manner in which the features are employed. Instructions also may be provided to users to notify them regarding policies about the use of information, including personally identifiable information, and manners in which each user may affect such use of information. Thus, information can be used to benefit a user, if desired, through receipt of relevant advertisements, offers, or other information, without risking disclosure of personal information or the user's identity.

One or more aspects of the exemplary embodiments may include a computer program that embodies the functions described and illustrated herein, wherein the computer program is implemented in a computer system that comprises instructions stored in a machine-readable medium and a processor that executes the instructions. However, it should be apparent that there could be many different ways of implementing the exemplary embodiments in computer programming, and the exemplary embodiments should not be construed as limited to any one set of computer program instructions. Further, a skilled programmer would be able to write such a computer program to implement an embodiment based on the appended flow charts and associated description in the application text. Therefore, disclosure of a particular set of program code instructions is not considered necessary for an adequate understanding of how to make and use the exemplary embodiments. Moreover, any reference to an act being performed by a computer should not be construed as being performed by a single computer as more than one computer may perform the act.

The exemplary systems, methods, and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments of the invention have been described above in detail, the description is merely for purposes of illustration. Various modifications of, and equivalent blocks and components corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

1. A computer-implemented method for using social networking information of a user to determine an authorization level for a peer-to-peer financial transaction, comprising:
receiving, by a computer, a request to initiate a financial transaction;
identifying, by the computer, network devices associated with potential financial transaction counter-parties within a configured geographic range of a user computing device associated with a payor, and identifying users associated with the identified network devices as potential financial transaction counter-parties;
searching, by the computer, social network information of the payor for occurrences of each of the identified financial transaction counter-parties;
assessing, by the computer, for each of the identified financial transaction counter-parties, a security risk of a financial transaction based on a strength of corresponding social network information connections of each of the identified financial transaction counter-parties to the payor, the strength based on the corresponding occurrences of each of the identified financial transaction counter-parties in the social network information of the payor and the quantity of previous financial transactions between the user and the financial transaction counter-party;
determining, by the computer, an authorization procedure required of the payor to complete the financial transaction with each of the identified financial transaction counter-parties based at least in part on the corresponding security risk of the financial transaction with each of the identified financial transaction counter-parties;
providing, by the computer, a list of a plurality of the identified financial transaction counter-parties for display on the user computing device, the list comprising the authorization procedure required for each identified financial transaction counter-party;
receiving, by a computer, a selection of one of the identified financial transaction counter-parties from the list of the identified financial transaction counter-parties;
receiving, by a computer, transaction details of the financial transaction, comprising at least a value of the financial transaction;
receiving, by the computer, a required authorization in accordance with the authorization procedure corresponding to the selected identified financial transaction counter-party for the financial transaction from the payor; and
processing, by the computer, the financial transaction in accordance with the selected one of the identified financial transaction counter-parties and the financial transaction details.

2. The computer-implemented method of claim 1, wherein the computer is a mobile network device associated with the payor.

3. The computer-implemented method of claim 1, wherein the computer is a peer-to-peer payment system, and
wherein the computer provides the list by communicating the list to a user network device associated with the payor.

4. The computer-implemented method of claim 1, wherein the authorization procedure is based on the quantity of previous financial transactions between the user and the financial transaction counter-party.

5. The computer-implemented method of claim 1, wherein the social network information comprises a social graph of the user.

6. The computer-implemented method of claim 5, wherein the social graph comprises information from at least one of a social network site and a contact application.

7. The computer-implemented method of claim 1, wherein the authorization procedure comprises responding to a request for at least one of:
a personal identification number;
a challenge question, a challenge-response test;
a password re-entry;
one or more financial transaction counter-party identification details; and
one or more financial transaction counter-party account information details.

8. (canceled)

9. The computer-implemented method of claim 1, wherein the strength of the financial transaction counter-party's social network information connections to the payor is based on one or more of:
a number of occurrences of the financial transaction counter-party in the social network;
a number of communications between the payor and the financial transaction counter-party;
a relationship level in a social network between the payor and the financial transaction counter-party;
a number of instances of financial transactions at a similar time;
a number of instances of financial transactions in a similar location a number of different social networks of the payor in which the financial transaction counter-party appears; and
a number of different contact applications of the payor in which the financial transaction counter-party appears.

10. A computer program product for using social networking information for a user to determine an authorization level for a peer-to-peer financial transaction, the computer program product comprising:
a computer-readable storage device having computer-readable program instructions stored therein, the computer-readable program instructions comprising:
computer program instructions for receiving a request to initiate a financial transaction;
computer program instructions for identifying network devices associated with potential financial transaction counter-parties within a configured geographic range of a user computing device associated with a payor, and identifying users associated with the identified network devices as potential financial transaction counter-parties;
computer program instructions for searching social network information of the payor for occurrences of each of the identified financial transaction counter-parties;
computer program instructions for assessing, for each of the identified financial transaction counter-parties, a security risk of a financial transaction based on a strength of corresponding social network information connections of each of the identified financial transaction counter-parties to the payor, the strength based on the corresponding occurrences of each of the identified financial transaction counter-parties in the social network information of the payor and the quantity of previous financial transactions between the user and the financial transaction counter-party;
computer program instructions for determining an authorization procedure required of the payor to complete the financial transaction with each of the identified financial transaction counter-parties based at least in part on the corresponding security risk of the financial transaction with each of the identified financial transaction counter-parties; and
computer program instructions for providing a list of a plurality of the identified financial transaction counter-parties for display on the user computing device, the list comprising the authorization procedure required for each identified financial transaction counter-party;
computer program instructions for receiving a selection of one of the identified financial transaction counter-parties from the list of potential financial transaction counter-parties;
computer program instructions for receiving transaction details of the financial transaction, comprising at least a value of the financial transaction;
computer program instructions for receiving a required authorization in accordance with the authorization procedure corresponding to the selected identified financial transaction counter-party for the financial transaction from the payor; and
computer program instructions for processing the financial transaction in accordance with the selected one of the identified financial transaction counter-parties and the financial transaction details.

11. The computer program product of claim 10, further comprising:
computer program instructions for receiving the required authorization for the financial transaction from the payor; and
computer program instructions for processing the financial transaction.

12. The computer program product of claim 10, wherein all of the computer program instructions are stored on a user network device associated with the payor.

13. The computer program product of claim 10, wherein all of the computer program instructions are stored peer-to-peer payment system, and
wherein the system provides the list by communicating the required authorization level to a user network device associated with the payor.

14. The computer program product of claim 10, wherein the authorization procedure is based on the quantity of previous financial transactions between the user and the financial transaction counter-party.

15. The computer program product of claim 10, wherein the social network information comprises a social graph of the user.

16. The computer program product of claim 15, wherein the social graph comprises information from at least one of a social network site and a contact application.

17. The computer program product of claim 10, wherein the authorization procedure comprises responding to a request for at least one of:
a personal identification number;
a challenge question, a challenge-response test;
a password re-entry;
one or more financial transaction counter-party identification details; and
one or more financial transaction counter-party account information details.

18. The computer program product of claim 10, wherein the strength of the financial transaction counter-party's social network information connections to the payor is based on one or more of:
a number of occurrences of the financial transaction counter-party in the social network;
a number of communications between the payor and the financial transaction counter-party;
a relationship level in a social network between the payor and the financial transaction counter-party;
a number of different social networks of the payor in which the financial transaction counter-party appears; and
a number of different contact applications of the payor in which the financial transaction counter-party appears.

19. An system for using the social networking content of a user to determine authorization levels required for a financial transaction, the apparatus comprising:
an application configured to execute on a user computing device associated with a payor and operable to:
communicate a request to conduct a financial transaction, the request comprising a request to initiate a financial transaction, an identification of the payor, and a location of the user computing device,
a computer configured to:
receive the request to initiate a financial transaction
identify network devices within a configured geographic range of the user computing device, and identifying users associated with the identified network devices as potential financial transaction counter-parties;
search social network information of the payor identified in the request for occurrences of each of the identified financial transaction counter-parties;
assess, for each of the identified financial transaction counter-parties, a security risk of a financial transaction based on a strength of corresponding social network information connections of each of the identified financial transaction counter-parties to the payor, wherein the strength is determined based on the corresponding occurrences of each of the identified financial transaction counter-parties in the social network information of the payor and the quantity of previous financial transactions between the user and the financial transaction counter-party;
determine an authorization procedure required of the payor to complete the financial transaction with each of the identified financial transaction counter-parties based at least in part on the corresponding security risk of the financial transaction with each of the identified financial transaction counter-parties;
provide a list of a plurality of the identified financial transaction counter-parties for display on the user computing device, the list comprising the authorization procedure required for each identified financial transaction counter-party;
receive a selection of one of the identified financial transaction counter-parties from the list of potential financial transaction counter-parties;
receive transaction details of the financial transaction, comprising at least a value of the financial transaction;
receive a required authorization in accordance with the authorization procedure corresponding to the selected identified financial transaction counter-party for the financial transaction from the payor; and
process the financial transaction in accordance with the selected one of the identified financial transaction counter-parties and the financial transaction details.

20. The apparatus of claim 19, the application further configured to:
receive the required authorization procedure;
receive an input of information to authorize the financial transaction; and
transmit to the computer the information to authorize the financial transaction.

21. (canceled)
